(19) United States
(12) Patent Application Publication
(10) Pub. No.: US 2015/0196131 A1
(43) Pub. Date: Jul. 16, 2015

(54) CUSHION WITH SUPPORTS FOR A MOTOR VEHICLE SEAT

(71) Applicant: Faurecia Sieges D'Automobile, Nanterre (FR)

(72) Inventors: Anne Isabelle DACOSTA-MALLET, Etrechy (FR); Samuel BAUDU, Boulogne Billancourt (FR)

(21) Appl. No.: 14/593,124

(22) Filed: Jan. 9, 2015

(30) Foreign Application Priority Data
Jan. 10, 2014 (FR) 1450205

(51) Int. Cl. A47C 27/08; B60N 2/64; B60N 2/02

(52) U.S. Cl. CPC A47C 27/083; A47C 27/081; B60N 2/02; B60N 2/64

(57) ABSTRACT

A seat cushion including at least one support, wherein the support includes at least one adjustment device, particularly inflatable, provided with at least two individually-adjustable bladders.

This application claims the priority benefit of French Patent application number 14/50205, filed on Jan. 10, 2014, the contents of which are incorporated herein by reference in their entirety to the maximum extent allowed by law.

### BACKGROUND

The present disclosure generally relates to motor vehicle seats and, more particularly, to the forming of a backrest or of a seat bottom piece of such seats fitted with lateral supports.

### DISCUSSION OF THE RELATED ART

Most motor vehicle seats are now fitted with supports, particularly of lateral supports, at the level of the backrest and/or of the seat bottom piece. Such supports take part in improving the comfort of a passenger sitting in the seat, by promoting a lateral hold at the level of the backrest and/or the seat bottom piece, particularly at the level of a central seat bottom piece portion and/or of a central backrest portion.

However, unless seats are made to measure, the positions and dimensions of the supports are determined for an average passenger size and corpulence. Further, making a seat to measure would not solve the issue linked to the fact that people having different corpulences and heights are likely to use a same seat.

### SUMMARY

An object of an embodiment is to overcome all or part of the disadvantages of known seats with supports.

Another object of an embodiment is to provide a motor vehicle seat having its bottom piece and/or its backrest fitted with supports, particularly lateral supports, adapted to passengers of different heights and corpulences.

Another object of an embodiment is to provide a solution adaptable during a period of use of the seat. Further, another object of an embodiment is to provide a solution requiring no action from the seat passenger.

Thus, an embodiment provides a seat cushion comprising at least one (lateral) support, wherein the support comprises at least one adjustment device, particularly inflatable, provided with at least two individually-adjustable bladders.

It is thus possible to adjust a dimension of the support and to adapt it, particularly, to the morphology of the seat passenger. The seat comfort and the passenger's hold are thus improved.

According to an embodiment, the bladders are distributed in different positions of the support.

The larger the number of bladders and the better they are distributed in the support, the better the possible fineness of the adjustment.

According to an embodiment, each bladder comprises at least one pressure sensor.

This enables to automate the adjustment by stopping it when the pressure of the support on the seat passenger is optimal.

According to an embodiment, the bladders are adjusted according to physical parameters of a passenger in contact with the seat cushion.

According to an embodiment, the bladders are automatically adjusted according to a pressure present therein.

According to an embodiment, the bladders are distributed in different positions according to a width and/or a length and/or a thickness of the support.

An embodiment also provides a motor vehicle seat comprising a seat cushion.

Of course, the different characteristics, variations, and/or embodiments of the present invention may be associated with one another according to various combinations since they are not incompatible or exclusive of one another.

The present invention will be better understood and other features and advantages with further appear on reading of the following detailed description of embodiments given for illustration purposes in relation with the accompanying drawings, provided as non-limiting examples, which may be used to complete the understanding of the present invention and the discussion of its achievement and, possibly, contribute to its definition, among which:

### BRIEF DESCRIPTION OF THE DRAWINGS

FIG. 1 is a simplified perspective view of an embodiment of motor vehicle seat with supports;

FIG. 2 is a simplified side view of an embodiment of a support of the seat of FIG. 1;

FIGS. 3A, 3B, and 3C are simplified front views illustrating several configurations of a seat backrest fitted with supports such as illustrated in FIG. 2;

FIG. 4 very schematically illustrates in the form of blocks an embodiment of a method of adjusting a pressure of contact of a support with a passenger; and

FIG. 5 is a graph showing the pressure according to a bladder adjustment duration illustrating an implementation mode of the method of FIG. 4.

### DETAILED DESCRIPTION

It should be noted that, in the drawings, the structural and/or functional elements common to the different embodiments may bear the same reference numerals. Thus, unless otherwise mentioned, such elements may have identical structural, dimensional, and material properties.

In the following description, when reference is made to terms qualifying absolute positions (such as “front”, “rear”, “top”, “bottom”, “left”, “right”, etc.), to terms qualifying relative positions (such as “above”, “under”, “upper”, “lower”, etc.) or to terms qualifying directions (such as “vertical”, “horizontal”, etc.), it is referred to a seat in a normal position of use in the usual vehicle motion direction.

For clarity, only those steps and elements which are useful to the understanding of the embodiments which will be described have been shown in the drawings and will be detailed. In particular, the forming of the other components of a seat or of a backrest has not been detailed, the described embodiments being compatible with usual ways to form these elements.

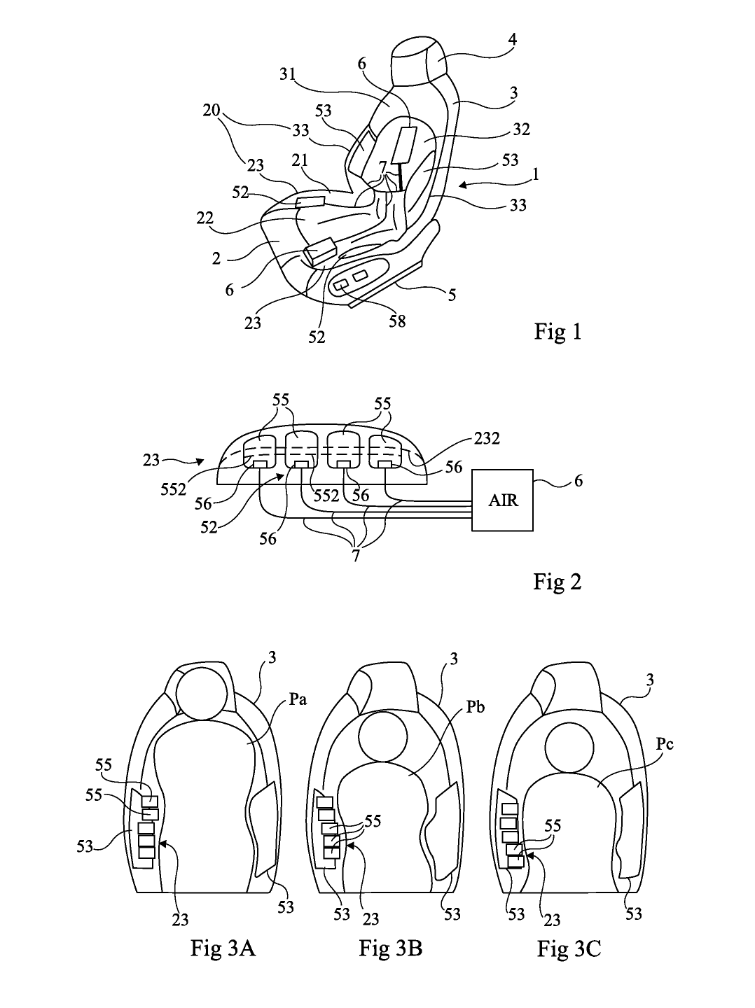

FIG. 1 is a simplified perspective view of an embodiment of a seat 1 for a motor vehicle comprising at least one support 20, particularly a lateral support, particularly arranged at the level of a seat bottom piece 2 and/or of a backrest 3 of seat 1. Seat 1 is for example assembled on rails 5 to be connected to the vehicle floor.

According to the example shown in FIG. 1, seat 1 thus comprises bottom piece 2 having backrest 3 hinged thereto, the latter being generally topped with a head restraint 4.

Seat bottom piece 2, respectively backrest 3, comprises at least one seat bottom piece cushion 21, respectively at least one backrest cushion 31, comprising at least one seat bottom center piece 22, respectively at least one backrest center piece 32. Generically, seat bottom piece cushion 21, respectively backrest cushion 31, forms a seat cushion according to the present disclosure.

Preferably, seat bottom center piece 22, respectively backrest center piece 32, is bordered with at least one support 20. Specifically, seat bottom center piece 22, respectively backrest center piece 32, is surrounded with at least one seat bottom piece support 23, respectively at least one backrest support 33.

Generically, seat bottom piece support 23, respectively backrest support 33, forms a support 20 according to the present disclosure.

Advantageously, seat bottom piece support 23, respectively backrest support 33, is arranged laterally with respect to seat bottom center piece 22, respectively to backrest center piece 32.

In the embodiment shown in FIG. 1, seat 1 comprises a plurality of seat bottom piece supports 23 and/or a plurality of backrest supports 33. In particular, seat 1 comprises two seat bottom piece supports 23, respectively two backrest supports 33, arranged on either side of seat bottom center piece 22, respectively of backrest center piece 32.

Seat bottom piece support 23, respectively backrest support 33, is fitted with at least one seat bottom piece adjustment device 52, respectively at least one backrest adjustment device 53, which aims at adjusting seat bottom piece support 23, respectively backrest support 33. Generically, seat bottom piece adjustment device 52, respectively backrest adjustment device 53, forms an adjustment device according to the present disclosure.

Preferably, “adjusting the support” means that seat bottom piece support 23, respectively backrest support 33, may have dimensions adapted according to the state of seat bottom piece adjustment device 52, respectively of backrest adjustment device 53. Thus the adjustment of seat bottom piece support 23, respectively of backrest support 33, concerns at least one width (that is, a lateral bulk) of seat bottom piece support 23, respectively of backrest support 33.

However, the adjustment of seat bottom piece support 23, respectively of backrest support 33, may also concern a length (that is, a depth for seat bottom piece support 23 and/or a height for backrest support 33) and/or a height (that is, a height for seat bottom piece support 23 and/or a depth for backrest support 33).

In particular, seat bottom piece adjustment device 52, respectively backrest adjustment device 53, is advantageously inflatable by means of at least one adjustment device 6, particularly an inflating device, for example, integrated to seat 1, particularly capable of being driven by means of a control member 58.

As a variation, only seat bottom piece cushion 21 of backrest cushion 31 comprises such supports 20, particularly lateral, provided with the adjustment device, in particular inflatable.

FIG. 2 is a simplified side view of an embodiment of support 20 of seat 1 of FIG. 1.

The embodiment shown in FIG. 2 is specific to seat bottom piece adjustment device 23 fitted with seat bottom piece adjustment device 52. However, the following disclosure applies in the same way to backrest support 33 fitted with backrest adjustment device 53.

More specifically, seat bottom piece adjustment device 52 comprises at least two bladders 55 (four bladders 55 in the example of FIG. 2), preferably inflatable, capable of being individually adjusted, in the case in point inflated, by means of adjustment device 6. For this purpose, bladders 55 are connected to adjustment device 6 by a series of respective pipes 7.

Adjustment device 6 is capable of allowing the inlet of a fluid, preferably air (AIR), into bladders 55, thus ensuring an inflation function. Further, adjustment device 6 may also be capable of enabling a fluid, preferably air (AIR), to be extracted out of bladders 55, thus fulfilling a deflation function.

Preferably, bladders 55 are arranged as close as possible to seat bottom piece 2, for example, under a cover of bottom piece 2, preferably between a padding and the cover of bottom piece 2.

In a configuration where all bladders 55 are deflated, such as illustrated in dotted lines 552 in FIG. 2, seat bottom piece support 23 has a minimum dimension, such as illustrated in dotted lines 232 in FIG. 2.

In a configuration where all bladders 55 are inflated, seat bottom piece support 23 has a maximum dimension such as illustrated in full line in FIG. 2.

Since bladders 55 are individually adjustable, it is now possible, not only to adapt the general dimension of support 20 but, further, to vary this dimension along support 20, according to the morphology of the passenger of seat 1.

According to a specific embodiment which will be illustrated hereafter, each bladder 55 is associated with a pressure sensor 56, for example, at the level of an adjustment valve of bladder 55, to transmit information relative to a pressure P present in bladder 55, in particular an inflation pressure, to adjustment device 6.

As a variation, in an embodiment where bladders 55 are individually adjustable, that is, individually connected to adjustment device 6, pressure P may be directly estimated by adjustment device 6 according to a resistance, particularly a resistance to inflation, applied by the concerned bladder 55.

FIGS. 3A, 3B, and 3C are simplified front views illustrating several configurations of backrest 3 of seat 1 fitted with backrest supports 33 such as illustrated in FIG. 2. However, the following description applies in the same way to seat bottom piece support 23 fitted with seat bottom piece adjustment device 52.

More particularly, FIGS. 3A, 3B, and 3C show three different situations of adjustment of backrest adjustment device fitting backrest supports 33, particularly according to different morphologies of passengers Pa, Pb, and Pc, symbolized by their respective figures.

The left-hand portion of FIGS. 3A to 3C illustrates an example of internal structure of backrest adjustment device 53 comprising five bladders 55. In the right-hand portion of FIGS. 3A to 3C, bladders 55 have not been detailed and only the general aspect of backrest support 33 is shown.

In the case of backrest 3, several bladders 55 are placed side by side, advantageously distributed at different heights along backrest support 33.

For example, assuming a tall passenger Pa, such as shown in FIG. 3A, the two upper bladders 55 of backrest adjustment device 53 are adjusted, and particularly inflated, to support passenger Pa on the sides.

FIG. 3B illustrates another example of a passenger Pb shorter and thinner than passenger Pa of FIG. 3A. In this example, the three lower bladders 55 of adjustment device 53 are adjusted, and particularly inflated.

FIG. 3C illustrates the case of a passenger Pc of same size as passenger Pb of FIG. 3B but of greater corpulence. In this case, only the two lower bladders 55 of adjustment device 53 are adjusted, and particularly inflated.

In the present disclosure, corpulence and height are the physical parameters of the passenger in contact with the seat cushion taken into account to adjust support 20.

As a variation, the configuration shown in FIG. 3C may illustrate the case of a passenger Pc of same height as passenger Pb of FIG. 3B but who would have slumped and would thus have slid along backrest 3. In this case, only the two lower bladders 55 of backrest adjustment device 53 are adjusted, and particularly inflated.

According to a specific embodiment, the adjustment of the different bladders 55, and particularly the adjustment of an intensity of the inflation, is performed automatically from one bladder 55 to the other.

Preferably, the adjustment is automatically performed due to the pressure sensor 56 fitting each of bladders 55 and which enables, according to the pressure exerted by the passenger of seat 1, to adjust the adjustment, particularly the inflation, of each bladder 55, so that the passenger feels a uniform pressure all along backrest support 33.

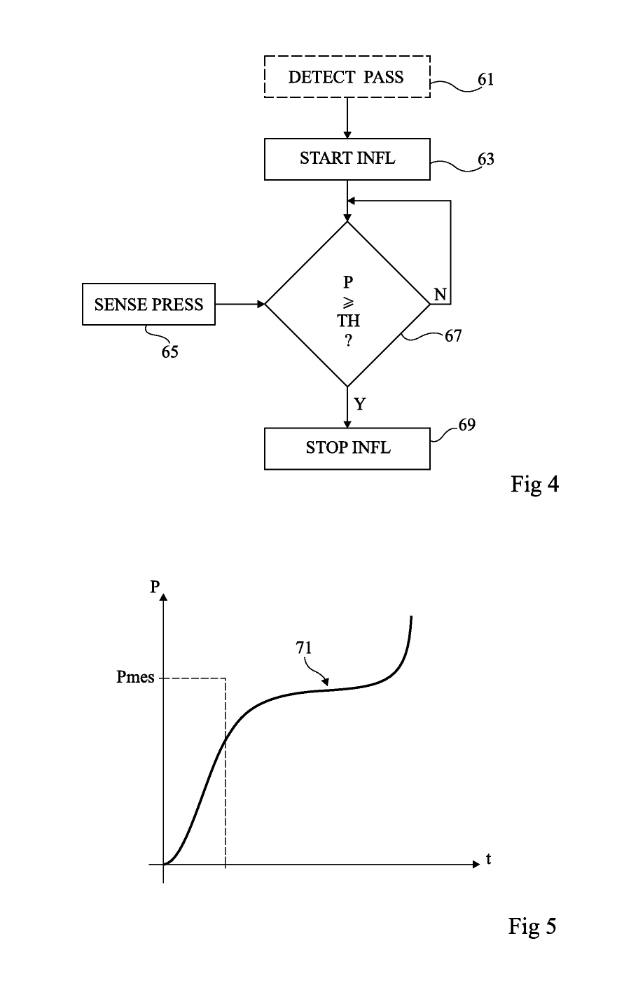

FIG. 4 very schematically illustrates in the form of blocks an embodiment of a method of adjusting the pressure of contact of supports 20 with the passenger of seat 1.

According to the pressure adjustment method, in a detection step 61, DETECT PASS, particularly optional and illustrated in dotted lines, a detector of the presence of a passenger in seat 1 is used. Such a presence detector may be a sensor integrated in seat bottom center piece 22, of the type currently used to detect a presence, for example, to tell the passenger to fasten his/her seat belt.

Once the passenger has been detected and/or possibly after he/she has actuated the adapted control member 58, in an adjustment step 63, START INFL, the different bladders 55 are adjusted, and particularly inflated, advantageously progressively.

At the level of each bladder 55, pressure sensor 56 detects the pressure, for example, at the level of the adjustment valve of bladder 55. The pressure detection is performed during a pressure sensing step 65, SENSE PRESS, which may be carried out simultaneously to or after adjustment step 63.

In a comparison step 67, as long as pressure P is lower than a threshold TH (output N), P≧TH?), bladder 55 keeps on being adjusted.

As soon as pressure P reaches threshold TH (output Y), the adjustment, and particularly the inflation, is stopped at a stop step 69, STOP INFL.

According to a specific embodiment illustrated in FIG. 5, threshold TH is variable and adjusted during the adjustment, and particularly the inflation. More particularly, FIG. 5 is a graph of the pressure versus the time of adjustment, and particularly of inflation, of bladder 55 illustrating the implementation mode of the method of FIG. 4.

FIG. 5 shows a curve 71 of pressure P in bladder 55 versus the time of adjustment, and particularly of inflation, and in the absence of external stress due to a passenger. Curve 71 is for example plotted for a control seat, or during a training phase started, for example, by the passenger while seat 1 is empty.

The exploitation of curve 71 enables to adjust threshold TH according to the real conditions. Actually, it is sufficient to determine whether a current sensed pressure Pmes exceeds the theoretical pressure at a given time, from the beginning of the adjustment, and particularly of the inflation.

According to a simplified embodiment, an adjustment mode, and particularly an inflation mode, which is not controlled by means of control member 58 fitting seat 1, may be provided, whereby the passenger can thus individually select the adjustment, and particularly the inflation, of the different bladders 55.

Various embodiments have been described. Various alterations, modifications, and improvements will readily occur to those skilled in the art. In particular, the practical implementation of the described embodiments is within the abilities of those skilled in the art based on the functional indications given hereabove and by using means usual per se.

For example, the adaptation of the number of bladders 55 according to the size of support 20 and to the adjustment fineness depends on the application and, for example, on the equipment level of seat 1.

Further, although the above embodiments have been described in relation with an individual adjustment, particularly an individual inflation, of bladders 55, it may be provided to adjust a plurality of bladders 55 simultaneously at the cost of a coarser adjustment.

Further, a plurality of adjustment devices may be provided in a same support. Further, the arrangement of bladders 55 may be refined and a plurality of bladders 55 may be provided to be stacked across the width and/or the thickness and/or the height of the support.

Of course, the invention is not limited to the previously-described embodiments, which are provided as an example only. It is likely to have various modifications, alterations and other variations, which can be devised by those skilled in the art within the framework of the present invention, and particularly any combinations of the different previously-described embodiments, separately or in association.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A seat cushion comprising at least one support, wherein the support comprises at least one adjustment device, particularly inflatable, provided with at least two individually-adjustable bladders.

2. The seat cushion of claim 1, wherein the bladders are distributed in different positions of the support.

3. The seat cushion of claim 1, wherein each bladder comprises at least one pressure sensor.

4. The seat cushion of claim 1, wherein the bladders are adjusted according to physical parameters of a passenger in contact with the seat cushion.

5. The seat cushion of claim 1, wherein the bladders are automatically adjusted according to a pressure present therein.

6. The seat cushion of claim 1, wherein the bladders are distributed in different positions according to a width and/or a length and/or a thickness of the support.

7. A motor vehicle seat comprising the seat cushion of claim 1.

8. A method of adjusting the seat cushion of claim 1, comprising at least:
an adjustment step during which each bladder is adjusted, and
a comparison step during which a pressure of the bladder is compared with a threshold to determine a stopping of the adjustment.

9. The method of claim 8, wherein the threshold is variable according to the adjustment time.
